(19) United States
(12) Patent Application Publication
(10) Pub. No.: US 2018/0018945 A1
(43) Pub. Date: Jan. 18, 2018

(54) METHOD FOR DISPLAYING THUMBNAILS ON A DISPLAY SCREEN, RELATED COMPUTER PROGRAM, ELECTRONIC DEVICE AND ELECTRONIC DISPLAY SYSTEM

(71) Applicant: PARROT DRONES, PARIS (FR)

(72) Inventors: Henri SEYDOUX, PARIS (FR); Luc BANDA, FONTENAY-SOUS-BOIS (FR)

(21) Appl. No.: 15/620,419

(22) Filed: Jun. 12, 2017

(30) Foreign Application Priority Data
Jul. 13, 2016 (FR) 16 56769

(51) Int. Cl. G09G 5/38; G05D 1/00; G06F 3/0482; G09G 5/377

(52) U.S. Cl. CPC G09G 5/38; G09G 5/377; G05D 1/0044; G06F 3/0482

(57) ABSTRACT

The invention relates to a method for displaying thumbnails on a display screen able to be positioned in a helmet, the helmet including two optical devices, intended to be positioned between the display screen and the eyes of a user.

This method comprises:
the display, on the display screen, of two separate thumbnails in two distinct positions, each thumbnail being associated with a respective eye of the user, and
the modification of the position of at least one thumbnail on the display screen, in the case of acquiring a control signal for modifying said position.

### FIELD OF THE INVENTION

The present invention relates to a method for displaying thumbnails on a display screen able to be positioned in a helmet, the helmet including two optical devices, intended to be positioned between the display screen and the eyes of a user.

The invention also relates to a non-transitory computer-readable medium including a computer program including software instructions which, when they are executed by a computer, implement such a processing method.

The invention also relates to an electronic apparatus able to be positioned in such a helmet, and an electronic viewing system comprising such an electronic apparatus.

### BACKGROUND OF THE INVENTION

A virtual reality helmet intended to be in contact with the face of a user is known. Such a helmet conventionally comprises a configured receiving support for receiving an electronic apparatus provided with a display screen, a supporting surface intended to be in contact with the face of the user, and two optical devices positioned between the receiving support and the supporting surface. The optical devices, such as optical lenses, are intended to be positioned between the display screen and the eyes of the user.

The electronic apparatus is for example removable relatively to the helmet, and is then typically a smartphone. Alternatively, the electronic apparatus is integrated to the helmet.

During the operation of such a helmet, two separate thumbnails are displayed in two distinct positions on the display screen of the electronic apparatus, each thumbnail being associated with a respective eye of the user, and the optical devices then carry out an optical transformation of the thumbnails so that the user perceives in his/her field of view a single image, further having a larger size than the thumbnails, in order to provide an immersive vision for the user.

In order to adapt such a helmet to various user morphologies, it is generally possible to adjust the distance between the eyes and the optical devices, for example via an adjustment wheel for the distance between the supporting surface and the optical devices. In certain cases, it is further possible to adjust the distance between both optical devices, in order to adapt the helmet to the distance between the pupils of the user (IPD-InterPupillary Distance), the latter being variable from one user to the other.

However, even after having carried out these preliminary adjustments, the user still does not benefit from satisfactory visual comfort by using such a helmet.

### SUMMARY OF THE INVENTION

The object of the invention is therefore to propose a method for displaying thumbnails on a screen able to be positioned in a helmet, giving the possibility of providing better eye comfort for the user.

For this purpose, the subject-matter of the invention is a method for displaying thumbnails on a display screen able to be positioned in a helmet, the helmet including two optical devices, intended to be positioned between the display screen and the eyes of a user, the method comprising:
the display, on the display screen, of two separate thumbnails in two distinct positions, each thumbnail being associated with a respective eye of the user, and
the modification of the position of at least one thumbnail on the display screen, in the case of acquiring a control signal for modifying said position.

The display method according to the invention then allows, when both thumbnails are displayed on the screen, modification of the position on the screen of at least one thumbnail, in the case of acquiring a control signal for such a modification of the position, this in order to adjust the position of the thumbnail relatively to the eye and to the associated optical device. The control signal of the modification of the position of the thumbnail stems, for example, from a control member actuated by the user.

In other words, the method according to the invention allows an adjustment of the positioning of the thumbnail relatively to the eye and to the associated optical device, when the helmet is placed on the head of the user.

Further, the user directly perceives the effect of such an adjustment through the image which he/she perceives in his/her field of view, this image resulting from the optical transformation of the thumbnails, carried out by the optical devices.

According to other advantageous aspects of the invention, the display method includes one or several of the following features, taken individually or according to all the technically possible combinations:
the position of each thumbnail is modified in the case of acquiring one or several signals for controlling a modification of said positions;
a thumbnail includes a portion of a pattern, the pattern being cut into two complementary portions, and the other thumbnail includes the other portion of the pattern, a correct positioning of the thumbnails relatively to the eyes and associated optical devices corresponding to a matching between both portions in the field of view of the user so as to reconstruct the pattern;
the pattern extends between two orthogonal directions, and the pattern is cut out along both orthogonal directions, each portion of the pattern extending along both orthogonal directions; and
the pattern has the shape of a cross.

A subject-matter of the invention is also a non-transitory computer-readable medium including a computer program including software instructions which, when they are executed by a computer, implement a method as defined above.

The subject-matter of the invention is also an electronic apparatus able to be positioned in a helmet, the helmet including two optical devices, the electronic apparatus comprising:
a display screen, both optical devices being intended to be positioned between the display screen and the eyes of a user,
a display module configured for displaying, on the display screen, two separate thumbnails in two distinct positions, each thumbnail being associated with a respective eye of the user,
an acquisition module configured for acquiring a signal for controlling a modification of the position of a thumbnail on the display screen, and
a modification module configured for modifying the position of said thumbnail, in the case of acquisition of said control signal.

According to another advantageous aspect of the invention, the electronic apparatus includes the following feature:
a thumbnail includes a portion of a pattern, the pattern being cut into two complementary portions, and the other thumbnail includes the other portion of the pattern, correct positioning of the thumbnails relatively to the eyes and to the associated optical devices corresponding to matching between both portions in the field of view of the user so as to reconstruct the pattern therein.

The subject-matter of the invention is also an electronic viewing system, comprising:
an electronic apparatus, including a display screen, the electronic apparatus being as defined above, and
a helmet including a configured receiving support for receiving the electronic apparatus, a supporting surface intended to be in contact with the face of a user, and two optical devices positioned between the receiving support and the supporting surface, the optical devices being intended to be positioned between the display screen and the eyes of the user.

According to other advantageous aspects of the invention, the electronic viewing system includes one or several of the following features, taken individually or according to all the technically possible combinations:
the system further comprises a configured receiving module for receiving at least one image from a motorized flying machine, such as a drone, in particular a drone with rotating wings, and the display module is connected to the receiving module and is able to display on the display screen each received image; and
the system is a viewing system in virtual reality.

### BRIEF DESCRIPTION OF THE DRAWINGS

These features and advantages of the invention will become apparent upon reading the description which follows, only given as a non-limiting example and made with reference to the appended drawings, wherein:

FIG. 1 is a perspective view of an electronic viewing system according to the invention, comprising an electronic apparatus provided with a display screen, and a helmet including a support for receiving the electronic apparatus, a supporting surface against the face of a user, and two optical devices positioned between the receiving support and the supporting surface, the viewing system further being connected to a handle equipped with two joysticks;

FIG. 2 is a partial schematic illustration of the helmet of FIG. 1, with the electronic apparatus;

FIG. 3 is a view of two thumbnails displayed on the screen of the electronic apparatus of FIG. 2;

FIG. 4 is a perspective view of the handle of FIG. 1; and

FIG. 5 is a flow chart of a display method according to the invention.

### DETAILED DESCRIPTION OF PREFERRED EMBODIMENTS

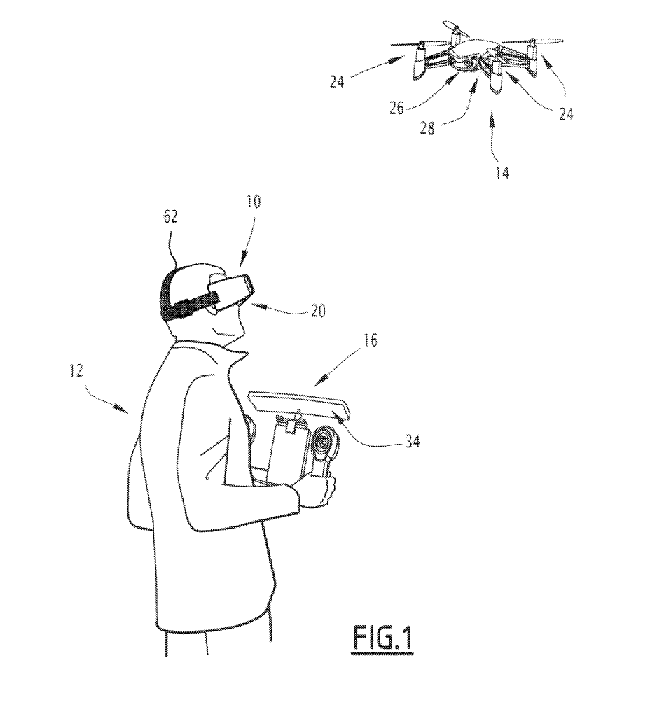

In FIG. 1, an electronic viewing system 10 gives the possibility to a user 12 of viewing images, notably images received from a motor-driven flying machine 14, such as a drone, in particular a drone with rotating wings. The electronic viewing system 10 is, for example, connected to a handle 16 via a data link, not shown, the data link being a radioelectric link or further a wired link.

The electronic viewing system 10 comprises an electronic apparatus 18 and a helmet 20 intended to be in contact with the face of the user 12, facing his/her eyes 22.

In the example of FIG. 1, the electronic viewing system 10 further comprises a reception module, not shown, configured for receiving at least one image from the motor-driven flying machine 14, the transmission of the image being carried out preferably by radioelectric waves.

The viewing system 10 is for example a viewing system in virtual reality, i.e. a system allowing the user 12 to view an image in his/her field of view, with a field of view angle, also called FOV (Field Of Vision, or Field Of View), having a large value, typically greater than 90°, preferably greater than or equal to 100°, in order to provide an immersive vision for the user 12.

The motor-driven flying machine 14 is known per se, and is for example a drone, i.e. an aircraft without any pilot onboard. The drone is for example a drone with rotating wings, including at least a rotor 24. In FIG. 1, the drone includes a plurality of rotors 24, and is then also called a multirotor drone. The number of rotors 24 is in particular equal to four in this example, the drone being then called a quadrirotor drone.

The motor-driven flying machine 14 includes an image sensor 26 configured for acquiring at least one image of a scene, and a transmission module 28 configured for transmitting, preferably via radioelectric waves, to the intention of an electronic piece of equipment, such as the reception module, the image(s) acquired by the image sensor 26.

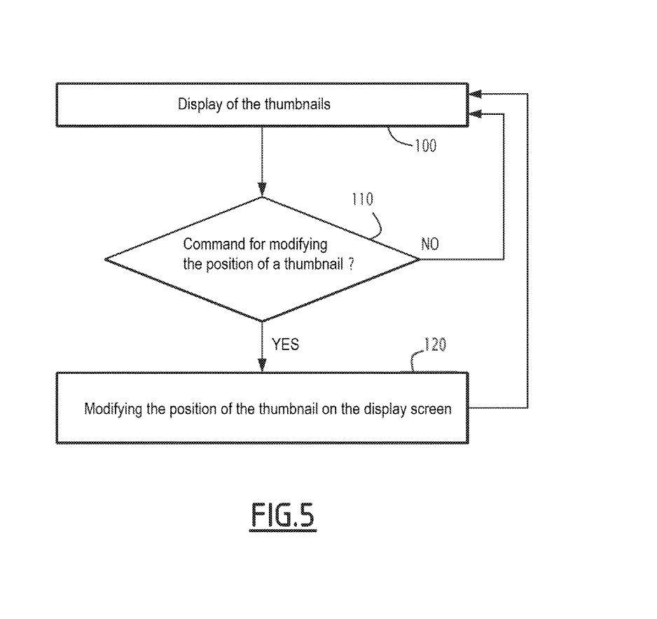

The handle 16, visible in FIGS. 1 and 4, is known per se, and for example allows the motor-driven flying machine 14 to be piloted. The handle 16 comprises two grip handles 30, each being intended to be grasped by a respective hand of the user 12, a plurality of control members, including two joysticks 32, each being positioned in proximity to a respective grip handle 30 and being intended to be actuated by the user 12, preferably by a respective thumb.

The handle 16 also comprises a radioelectric antenna 34 and a radioelectric transceiver, not shown, for exchanging data via radioelectric waves with the motor-driven flying machine 14, both in an uplink and in a downlink.

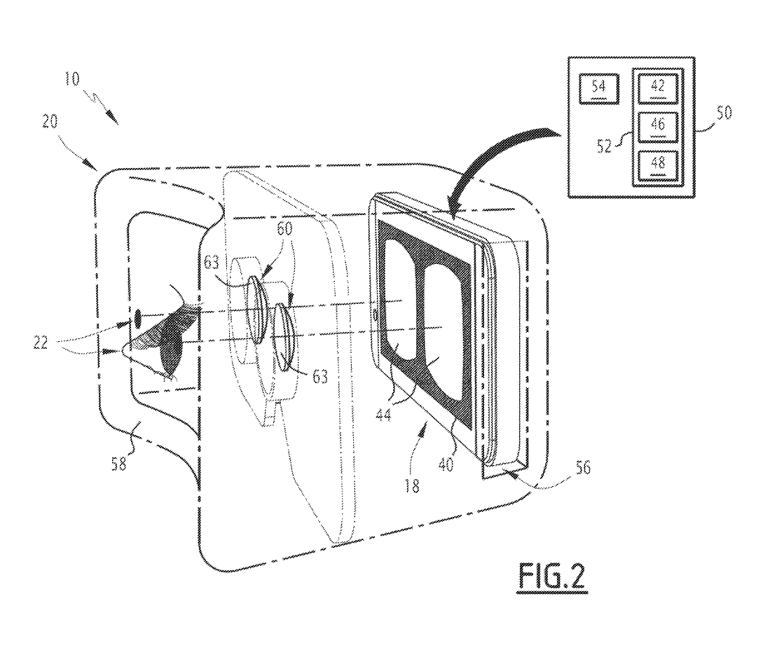

The electronic apparatus 18 is able to be positioned in the helmet 20, as illustrated in FIG. 2. The electronic apparatus 18 is for example a smartphone.

In the example of FIG. 2, the electronic apparatus 18 is removable relatively to the helmet 20. In an alternative not shown, the electronic apparatus 18 is integrated to the helmet 20.

The electronic apparatus 18 comprises a display screen 40, a display module 42 configured for displaying the data on the display screen 40, notably two separate thumbnails 44 in two distinct positions, as illustrated in FIG. 2, each thumbnail 44 being associated with a respective eye 22 of the user 12. In the described example, the display module 42 is further connected to the reception module, and is then able to display on the display screen 40, each image received by the reception module.

The electronic apparatus 18 further comprises an acquisition module 46 configured for acquiring a control signal for modifying the position of a thumbnail 44 on the display screen 40, and a modification module 48 configured for modifying the position of said thumbnail 44, in the case of acquisition of said control signal by the acquisition module 46. The modification module 48 is further configured for modifying the position of each thumbnail 44 on the display screen 40, in the case of acquisition by the acquisition module 46 of one or several control signals for modifying said positions.

In the example of FIG. 2, the electronic apparatus 18 comprises an information processing unit 50, formed for example by a memory 52 and a processor 54 associated with the memory 52.

The helmet 20 includes a reception support 56 configured for receiving the electronic apparatus 18, a supporting surface 58 intended to be in contact with the face of the user 12, and two optical devices 60 positioned between the reception support 56 and the supporting surface 58, the optical devices 60 being intended to be positioned between the display screen 40 and the eyes 22 of the user 12, as illustrated in FIG. 2.

The helmet 20 further includes a holding strap 62, visible in FIG. 1, giving the possibility of maintaining the helmet 20 on the head of the user 12.

In the example of FIG. 2, the display module 42, the acquisition module 46 and the modification module 48 are each made in the form of an executable piece of software by the processor 54. The memory 52 of the information processing unit 50 is then capable of storing a display piece of software configured for displaying the data on the display screen 40, notably both separate thumbnails 44 in two distinct positions, an acquisition piece of software configured for acquiring a signal for controlling a modification of the position of a thumbnail 44 on the display screen 40, and a modification piece of software configured for modifying the position of said thumbnail 44 on the display screen 40 in the case of acquisition by the acquisition piece of software of said control signal. The processor 54 of the information processing unit 50 is then able to execute the display piece of software, the acquisition piece of software and the modification piece of software.

In an alternative not shown, the display module 42, the acquisition module 46 and the modification module 48 are each made in the form of a programmable logic component, such as an FPGA (Field Programmable Gate Array), or further in the form of a dedicated integrated circuit, such as an ASIC (Application Specific Integrated Circuit).

Each thumbnail 44 has a predefined shape and a predefined size, this shape and this size depending on the optical device 60 associated with the respective thumbnail 44, in particular of the optical transformation able to be carried out by this optical device 60. In other words, the thumbnail 44 corresponds to the reverse optical transformation of what should be perceived by the user 12 in his/her field of view for this thumbnail 44.

Both thumbnails 44 have preferably an identical shape. Both thumbnails 44 preferably have a substantially identical size, i.e. have dimensions substantially equal to within plus or minus 10%.

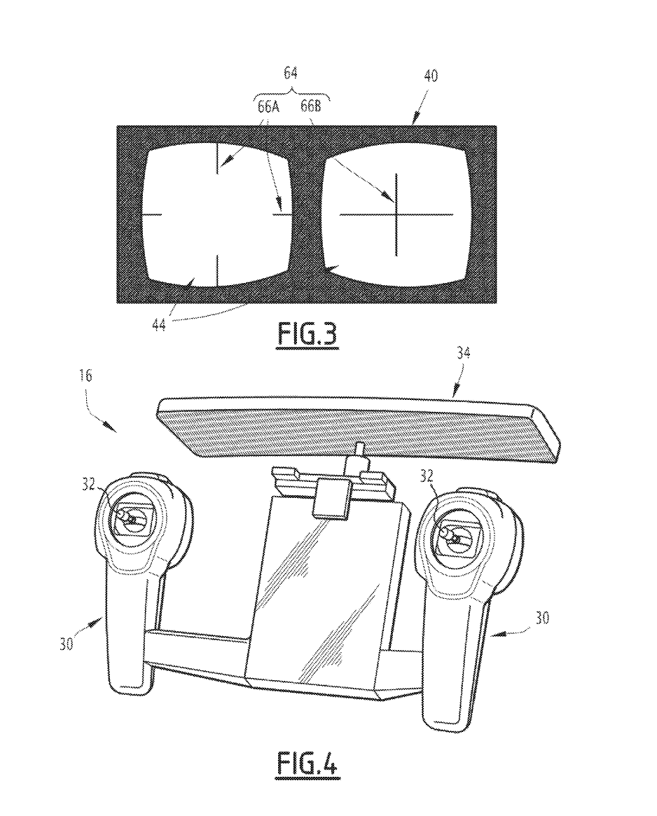

By thumbnail, is meant a predefined area of the image which is displayed on the display screen 40, this predefined area being preferably surrounded by a dark strip, such as a black strip, as illustrated in FIGS. 2 and 3. As the thumbnails 44 are separate, the areas of the displayed image on the display screen 40 are also separate.

Each optical device 60 is configured for carrying out an optical transformation of a corresponding thumbnail 44 by deforming it and by enlarging it, so that the user 12 perceives in his/her field of view an overall image, resulting from the optical transformation of both thumbnails 44 carried out by the two optical devices 60.

Each optical device 60 is for example an optical lens 63. Alternatively, not shown, each optical device 60 includes a set of mirrors, or further a set of optical lenses, electronically controlled.

In the example of FIG. 3, with a view of the display screen 40 on which two thumbnails 44 are displayed, a pattern 64 is cut into two complementary portions 66A, 66B, i.e. a first portion 66A and a second portion 66B. One of the two thumbnails 44 then includes the first portion 66A of the pattern 64, and the other thumbnail 44 includes the second portion 66B of said pattern 64. With this particular content of the thumbnails 44, i.e. one of the two thumbnails 44 including a portion 66A of the pattern, and the other thumbnail 44 including the other portion 66B of said pattern, a correct positioning of the thumbnails 44 relatively to the eyes 22 and the associated optical devices 60 then corresponds to a matching between both portions 66A, 66B in the field of view of the user 12, so that the user 12 may reconstruct the pattern 64 in his/her field of view.

The pattern 64 preferably extends along two orthogonal directions, as illustrated in FIG. 3, and the pattern 64 is then cut along both orthogonal directions, each portion 66A, 66B of the pattern 64 extending along both orthogonal directions. The pattern 64 is for example with the shape of a cross.

The operation of the electronic viewing system 10 according to the invention, in particular of the electronic apparatus 18, will now be described by means of FIG. 5 illustrating a flow chart of the display method according to the invention, applied by computer.

The display method according to the invention gives the possibility of carrying out a calibration of the display of the electronic device 18 relatively to the helmet 20, when the helmet 20 is positioned on the head of the user 12, in particular a calibration of the positioning of the thumbnails 44 displayed on the display screen 40 relatively to the optical devices 60 and to the eyes 22.

During a step 100, the thumbnails 44 are displayed on the display screen 40 by the display module 42, both thumbnails 44 being displayed at the same time, so that the user 12 perceives an overall image in his/her field of view. Both thumbnails 44 are for example simultaneously or quasi simultaneously displayed by the display module 42, for example with a time difference between the respective displays of the thumbnails 44 of less than 40 ms, preferably less than 10 ms.

During a next step 110, the acquisition module 46 determines whether it has received a control signal for modifying the position of one of the thumbnails 44 on the display screen 40, and acquires this control signal if necessary.

In the case of acquisition of a control signal for modifying the position of one of the thumbnails 44, the modification module 48 modifies, during a next step 120, the position of said thumbnail 44. The position of each thumbnail 44 may be modified independently of the position of the other thumbnail 44.

During step 120, the position of each thumbnail 44 is modified in the case of acquisition of one or several control signals for modifying the positions of both thumbnails 44.

After step 120, the display method returns to step 100. One skilled in the art will further understand that the thumbnails 44 are preferably displayed permanently during this phase for calibration of the positioning of the thumbnails 44 relatively to the optical devices 60 and to the eyes 22 of the user 12.

When during step 110, the acquisition module 46 has not received any control signal for modifying the position of a thumbnail 44, the method directly returns to step 100, without carrying out step 120.

The control signal for modifying the position of the thumbnail(s) 44 in the example of FIGS. 1 and 4 stems from one of the two joysticks 32, actuated by the user 12. As an example, an actuation of the left joystick 32 by the user 12 causes a modification in the position of the thumbnail 44 located on the left in FIG. 3, and therefore causes the displacement of this left thumbnail on the screen 40. Similarly, an actuation of the right joystick 32 by the user 12 causes a modification of the position of the thumbnail 44 located on the right in FIG. 3, and causes the displacement of this right thumbnail on the screen 40.

A displacement of a joystick 32 by the user 12 along a given direction then causes a displacement of the thumbnail 44 associated with this joystick 32 along the same direction, which thus gives the possibility of facilitating the modification of the position of said thumbnail 44 by the user 12.

Further, the distance between the position of the thumbnail 44 after modification and the position of the thumbnail 44 before modification preferably depends on the value of the displacement carried out by the corresponding joystick 32. This distance between the positions after modification and before modification of the thumbnail 44 is preferably an increasing function of said displacement.

More generally, the control signal of the modification of the position of the thumbnail(s) 44 stems from a control member actuated by the user 12. The control member for example is the joystick 32 described earlier, a trackball, an adjustment wheel, one or several selection buttons, in particular a pad with four directional arrows, or further a tactile surface.

When the control member has the shape of a trackball, a displacement of the trackball in a given direction causes displacement of the thumbnail 44 in this direction on the display screen 40, the amplitude of the displacement of the thumbnail 44 on the screen 40 being a function of the amplitude of the applied movement to the trackball by the user 12; preferably an increasing function, i.e. the amplitude of the displacement of the thumbnail 44 increases when the amplitude of the movement applied to the trackball increases.

When the control member has the shape of a pad with four arrows with down and up arrows for displacing the thumbnail 44 along a vertical direction and left and right arrows for displacing the thumbnail 44 along a horizontal direction, pressing on the up arrow causes a displacement of the thumbnail 44 along the vertical direction and upwards on the display screen 40, the displacement of said thumbnail 44 then being a function of the number of pressing operations on said up arrow and/or on the duration of the pressure on said up arrow; preferably an increasing function. Similarly, pressing on the down arrow causes a displacement of the thumbnail 44 along the vertical direction and downwards; or further pressing on the left arrow, respectively on the right arrow, causes a displacement of the thumbnail 44 along the horizontal direction to the left, respectively to the right. There also, the amplitude of the displacement of the thumbnail 44 is preferably function of the number of pressing operations on the corresponding arrow and/or on the duration of pressing on said arrow; preferably an increasing function.

When the control member is in the form of a tactile surface, sliding a finger along this tactile surface in a given direction causes a displacement of the thumbnail 44 in this direction on the display screen 40, the amplitude of the displacement of the thumbnail 44 on the screen 40 being a function of the amplitude of the sliding of the finger; preferably an increasing function.

Alternatively, the control signal of the modification of the position of the thumbnail(s) 44 stems from a sensor able to determine a position of the thumbnail 44 relatively to the eye 22 and to the associated optical device 60, the control signal then being generated by said sensor in the case of poor positioning of the thumbnail 44 relatively to the eye 22 and to the associated optical device 60; in particular when the thumbnail 44, the eye 22 and the associated optical device 60 are not aligned, for example when the center of the thumbnail 44, the center of the optical device 60 and the center of the retina are not aligned.

The display method according to the invention then gives the possibility, because of the modification of the position of the thumbnail(s) 44 on the display screen 40 in the case of acquisition of a corresponding control signal, of easily adjusting the position of the thumbnail 44 relatively to the eye 22 and to the associated optical device 60, and so improve the positioning of the thumbnail 44 relatively to the eye 22 and to the associated optical device 60, in order to provide greater visual comfort to the user 12.

Further, when a misalignment is present between one of the thumbnails 44 and the optical device 60 and the associated eye 22, the latter is not necessarily perceivable in a simple way by the user 12, the eyes 22 actually having a tendency of correcting naturally such a misalignment, notably if it has a low value, i.e. of the order of a few degrees, this by convergence or by divergence along the misalignment to be corrected. The user 12 then actually perceives a single image in his/her field of view, at not two images shifted relatively to each other, but such a correction generates visual discomfort over time, the ocular muscles being tired gradually as such a correction is necessary.

The fact of then having a thumbnail 44 including the first portion 66A of the pattern 64, and the other thumbnail 44 including the second portion 66B of the pattern 64, the first and second complementary portions 66A, 66B, then give the possibility of more easily detecting a poor positioning of a thumbnail 44 relatively to the other one.

Indeed, a correct positioning of the thumbnails 44 relatively to the associated eyes 22 and optical devices 60 then corresponds to a matching between both complementary portions 66A, 66B in the field of view of the user 12, then giving him/her the possibility of reconstructing the pattern 64 in his/her field of view. On the contrary, when the thumbnails 44 are not aligned relatively to the associated eyes 22 and optical devices 60, both portions 66A, 66B do not coincide in the field of view of the user 12, and the pattern 64 is then not reconstructed in his/her field of view, the pattern 64 appearing on the contrary in a fragmented way.

This then gives the possibility of further improving the visual comfort for the user 12, the latter may more easily detect an alignment defect between the thumbnails 44, the optical devices 60 and his/her eyes 22, in order to correct it then by modification of the position of at least one thumbnail 44 on the display screen 40. The user 12 may thus avoid fatigue of his/her ocular muscles, which would in the long run generate visual discomfort.

It is thus conceivable that the electronic apparatus 18 and the display method according to the invention give the possibility of providing better visual comfort for the user 12, by allowing better calibration of the positioning of the thumbnails 44 relatively to the optical devices 60 and to the eyes 22 of the user 12.

1. A method for displaying thumbnails on a display screen able to be positioned in a helmet, the helmet including two optical devices, intended to be positioned between the display screen and the eyes of a user,
the method comprising:
the display, on the display screen, of two separate thumbnails in two distinct positions, each thumbnail being associated with a respective eye of the user,
the modification of the position of at least one thumbnail on the display screen, in the case of acquisition of a control signal for modifying said position.

2. The method according to claim 1, wherein the position of each thumbnail is modified in the case of acquisition of one or several control signals for modifying said positions.

3. The method according to claim 1, wherein a thumbnail includes a portion of a pattern, the pattern being cut into two complementary portions, and the other thumbnail includes the other portion of the pattern, a correct positioning of the thumbnails relatively to the eyes and associated optical devices corresponding to a matching between both portions in the field of view of the user so as to reconstruct the pattern therein.

4. The method according to claim 3, wherein the pattern extends along two orthogonal directions, and the pattern is cut out along both orthogonal directions, each portion of the pattern extending along both orthogonal directions.

5. The method according to claim 4, wherein the pattern has the shape of a cross.

6. A non-transitory computer-readable medium including a computer program including software instructions which, when they are executed by a computer, implement a method according to claim 1.

7. An electronic apparatus able to be positioned in a helmet, the helmet including two optical devices,
the electronic apparatus comprising:
a display screen, both optical devices being intended to be positioned between the display screen and the eyes of a user,
a display module configured for displaying on the display screen two separate thumbnails in two distinct positions, each thumbnail being associated with one respective eye of the user,
an acquisition module configured for acquiring a control signal for modifying the position of a thumbnail on the display screen, and
a modification module configured for modifying the position of said thumbnail, in the case of acquisition of said control signal.

8. The electronic apparatus according to claim 7, wherein a thumbnail includes a portion of a pattern, the pattern being cut into two complementary portions, and the other thumbnail includes the other portion of the pattern, a correct positioning of the thumbnails relatively to the eyes and associated optical devices corresponding to a matching between both portions in the field of view of the user so as to reconstruct the pattern therein.

9. An electronic viewing system, comprising:
an electronic apparatus, including a display screen, and
a helmet including a reception support configured for receiving the electronic apparatus, a supporting surface intended to be in contact with the face of a user, and two optical devices positioned between the reception support and the supporting surface, the optical devices being intended to be positioned between the display screen and the eyes of the user,
wherein the electronic apparatus is according to claim 7.

10. The system according to claim 9, wherein the system further comprises a reception module configured for receiving at least one image from a motor-driven flying machine and
wherein the display module is connected to the reception module and is able to display on the display screen each received image.

11. The system according to claim 9, wherein the system is a viewing system in virtual reality.
